(19) United States
(12) Patent Application Publication
(10) Pub. No.: US 2004/0199446 A1
(43) Pub. Date: Oct. 7, 2004

(54) Financing the donation of life insurance proceeds

(76) Inventor: Jeffrey Lange, New York, NY (US)

Correspondence Address: KENYON & KENYON, ONE BROADWAY, NEW YORK, NY, 10004, US

(21) Appl. No.: 10/389,335

(22) Filed: Mar. 14, 2003

(51) Int. Cl. G06F 17/60

(52) U.S. Cl. 705/36; 705/4

(57) ABSTRACT

This invention enables donations of life insurance proceeds to beneficiaries, such as individuals, for-profit entities, and/or non-profit entities, such as universities and colleges, at no cost to the donors. The life insurance policies are held in trust and funded by endowment investment funds. Alternatively, loans collateralized with life insurance policies held by life insurance trusts, are taken by the life insurance trusts from lenders to purchase annuities that provide annuity payments to the trusts for the life of the donors. The annuity payments finance the loans and the life insurance policies and are insured by reinsurance companies for the life of each donor. Investment funds invest in the lender and/or the reinsurance company. The proceeds or death benefits of the life insurance policies are allocated, in part, to compensate and provide a return on the funding or financing of the life insurance policy, and in part, to the beneficiary.

### FIELD OF THE INVENTION

The present invention relates generally to systems, methods, plans and products for enabling the donation of life insurance proceeds to beneficiaries, such as individuals, for-profit entities or institutions, or non-profit institutions or entities, such as universities and colleges. The present invention generates beneficial interests for the beneficiaries, such as nonprofit institutions or entities in life insurance policies of the benefactors or donors at no cost to the benefactors or donors, while providing a return to investors supporting, the enablement of such donations. The investors either invest in a non-profit investment fund that finance the life insurance policies, or in a for-profit investment fund supporting the provision of mortality-linked loans and insured annuities, the mortality-linked loans being secured or collateralized with the life insurance policies, and used to purchase the insured annuities. The insured annuities, in turn, finance the loans and the life insurance policies.

### BACKGROUND OF THE INVENTION

A number of uses for life insurance products have emerged in recent years to fulfill a dual investment and future liability funding purpose. One prominent example is Corporate Owned Life Insurance (COLI) plans, in which a corporation purchases life insurance on its employees. The corporation pays all premiums for the life insurance and receives the bulk of the death benefits. Under the Internal Revenue Code Section 101(a)(1), the death benefit proceeds received by the corporation are tax free. Because of the tax free nature of the death benefits, the rate of return earned on the premiums paid to purchase the insurance is typically attractive to the corporation on an after-tax basis. The returns from COLI (and related plans, such as Bank Owned Life Insurance or BOLI) are often used to fund future compensation and benefit liabilities of the corporation. In many cases, COLI returns are used to fund so called nonqualified retirement plans, which provide pension, health, and other retirement benefits to former employees of the corporation. These benefits are more easily defined, funded and administered using a COLI plan as compared to traditional methods of funding qualified benefit programs.

Even more recently, nonprofit institutions such as churches, foundations, and charities have become interested in using the unique features of life insurance to fund future liabilities and operations. Known as ROLI (for Religious Owned Life Insurance), FOLI (for Foundation Owned Life Insurance), and CHOLI (for Charity Owned Life Insurance), these programs have involved the enlisting of past or future donors or benefactors for the purpose of purchasing insurance on a pool of such donors or benefactors. The nonprofit entity usually borrows the money to pay for the insurance premiums from a bank (or possibly the insurance company itself), and receives death benefits when its donors die. The death benefits are then used to repay the loans from the bank or the insurance company. The balance of the death benefits, if any, is used to fund the nonprofit entities' primary objectives, such as funding research, furthering religious programs, or disbursing benefits to the needy.

A number of problems with respect to systems and methods for purchasing life insurance to fund nonprofit institutions have emerged and remain unaddressed. The first problem is legal and regulatory. Most state insurance codes have a number of laws which address the requirement of an “insurable interest” in the context of life insurance. As a general matter, the owner of a policy is required to have an insurable interest, meaning that there must be some relationship between the owner of the policy and the insured in which the owner would suffer some form of loss should the insured die. In many cases, state law does not require that the beneficiary of a life insurance policy have an insurable interest. For example, California Insurance Code section 10110.1(b) states that “[a]n individual has an unlimited insurable interest in his or her own life . . . and may lawfully take out a policy of insurance on his or her own life . . . and have the policy made payable to whomsoever he or she pleases, regardless of whether the beneficiary designated has an insurable interest.”

Some states, however, have additional statutory law that restricts the purchase of a policy in other situations. For example, the New York Insurance Laws, section 3205(b)(2) states that “No person shall procure or cause to be procured, directly or by assignment or otherwise any contract of insurance upon the person of another unless the benefits under such contract are payable to the person insured or his personal representatives, or to a person having, at the time when such contract is made, an insurable interest in the person insured.” Such states have carved out exceptions for nonprofit institutions. For example New York Insurance Laws section 3205(b)(3) provides a safe harbor for nonprofit entities which “procure or cause to be procured, directly or by assignment or otherwise, a contract of life insurance upon the person of another and may designate itself or cause to have itself designated as the beneficiary of such contract.”

Despite such exceptions and safe harbor provisions, CHOLI and other nonprofit insurance owned programs have encountered significant problems. First, the tax free nature of the investment returns to nonprofits is not material since these institutions are not subject to income tax. The investment returns for nonprofits from owning or holding beneficial interests in insurance policies on benefactors must be attractive on a nominal, i.e., pre-tax basis. While this is possible, most, if not all charities, which have implemented CHOLI programs have used lenders to provide the funds to purchase the policies. The cost of the funds to the charities can reduce substantially, if not all, of the investment returns to such programs, depending upon the cost of lender funds, the nature of the policies underwritten, and, of course, the mortality experience of the benefactors insured. Second, the charities which have to date employed CHOLI programs do not have any efficient means for selecting an underwriting program of benefactors to achieve superior investment returns on a nominal basis. Such different means would include (i) having access to a well-defined class of insureds with higher mortality risk who happen to be benefactors; (2) underwriting these benefactors with the preferred life insurance products; and (3) financing the underwriting of the insurance efficiently. Third, state insurance regulators have so far frowned upon the existing CHOLI programs which rely upon private for-profit outside lenders to provide the funding to purchase the life insurance on the benefactors. For example, in May 2002, Michigan regulators denied approval to a plan with such outside investors stating that the investors “do not have an insurable interest but an investment interest.” (“Dying to Donate: Charities Invest in Death Benefits,” The Wall Street Journal, Feb. 6, 2003).

With respect to nonprofit universities, colleges and other nonprofit educational institutions which have significant fundraising needs and programs, use of insurance products to effectively increase donations or enhance investment returns has been problematic. First, such fundraising programs have not targeted a defined underwriting class of benefactors, such as, for example, an alumni cohort of a specific age and graduating year, i.e., factors directly related to mortality risk. Second, existing uses of life insurance policy products for donation purposes have been hampered to the extent that traditional gifting techniques have been relied upon. For example, universities and colleges have solicited donors to buy life insurance policies and either transfer ownership of them or seek to be named as beneficiaries in the policies. Obviously, this requires the donor to purchase the policy and maintain premium payments over the life of the policy, which is a costly undertaking. Third, existing uses of annuity products have also been less than satisfactory. For example, the college or university will seek to have a donor purchase an annuity which pays the donor an income while he is alive with a large death benefit payable to the college or university upon death. The main difficulty with these types of arrangements involving annuities which provide for both donor life income and a benefit to a beneficiary upon death is that large upfront premium payments by donors are usually required.

Other existing problems for nonprofit entities' or profit entities' funding using life insurance products include, but are not limited to:

1) State insurable interest rules: As indicated, most states have insurable interest rules applicable to nonprofit owners and beneficiaries of donor life insurance. Some of the potential problems with insurable interest include:

(a) If the policy is found to have violated the insurable interest rules when issued, the issuing insurance company can later argue that the policy was void from the beginning and will not pay the death benefit at the insured's death. While nonprofit or charitable institutions are assumed to have an insurable interest in the life of a donor in most states, there may be unusual provisions in the state code which must be followed exactly in order to avoid having the contract nullified later. For example, if a nonprofit located in New York purchases a policy on the life of a donor residing in California, the insurable interest rules under New York law (the location of the policy owner) must be met.

(b) If the beneficiary or donor purchases a policy but the ownership is immediately transferred to another party, the insurance company may later attempt to void the contract if the insurable interest rules for either owner are in any way not met.

(c) In some cases where the insurance purchase did not meet state insurable interest laws, the IRS has denied income, gift, and estate tax charitable deductions.

2) Nonprofit fiduciary duties: A beneficiary which is a nonprofit or charitable institution will have fiduciary restrictions regarding the type of assets that it may invest in. For most charities, investing in or originating life insurance on donors may not be considered suitable investments under their existing investment mandates.

3) Capital Constraints: Most nonprofits will not have the capital to fund the required premiums for originated life insurance on donors. Presumably, this capital would need to be raised from other donors which greatly impedes the efficiency of using life insurance as a means of funding nonprofit entities. Furthermore, as already indicated, nonprofit institutions which raise money from outside lenders or investors may run afoul of state insurance codes or insurance regulations requiring those receiving life insurance death benefits to have an insurable interest (e.g., New York Insurance Code Section 3502(a)(2)).

### SUMMARY OF THE INVENTION

To solve these and other problems with respect to general nonprofit owned insurance plans and generating insurance-based funding for beneficiaries that can be for-profit or non-profit entities or individuals, and for the purpose of providing a plan applicable to such beneficiaries, the present invention provides methods and systems and a plan and product utilizing life insurance for simultaneously (1) generating large sums of life insurance donations to beneficiary individuals or entities; (2) providing no-cost incentives to individual benefactors or donors of such entities, such as alumni of a university or college, to make such life insurance donations; (3) funding or financing the purchase of life insurance on the benefactors; (4) optimizing the returns on the funding or financing net of donated life insurance proceeds to the beneficiaries; and (5) complying with state insurance law and regulations related to insurable interest requirements for nonprofit entities or other beneficiaries.

Some of the advantageous aspects of the present invention may include the ability to generate excess risk adjusted returns for endowment investment funds, create substantial amounts of life insurance gifts to the nonprofit entities or other beneficiaries at no cost to the donor, and provide methods for the efficient implementation of the program for optimizing investment fund returns, creating maximum donations to beneficiaries, such as the nonprofit entities, and providing means to maximize participation by individual benefactors, all while satisfying state legal and regulatory requirements.

One feature of the present invention is to provide efficient methods and systems for enabling or facilitating the donation of life insurance proceeds to nonprofit entities. In particular, a feature of the present invention is to provide superior means for universities, colleges, and other educational institutions with substantial endowments to both enhance the rate of return on endowment assets and also dramatically increase the amount of donor gifts through life insurance.

A need is recognized for methods and systems to both enhance the returns of university and college endowment funds without undue risk taking while also simultaneously increasing the amount of donor life insurance benefits earmarked for such institutions.

A need is recognized for methods and systems which simultaneously solicit donor interest in providing life insurance death benefits to the colleges and universities of their choice while also simultaneously financing the purchase of such life insurance policies using funds from the endowments of the colleges and universities in such a manner which is not inconsistent with state insurance laws or regulations.

A need is also recognized to both finance and underwrite a select group of alumni of such colleges and universities such that the pool of insurance policies owned by the endowments which provide the funding for the policies obtain risk adjusted excess returns on the capital used to pay the policy premiums.

According to one embodiment of the present invention, as described herein, a method, system and plan for using life insurance products to achieve a simultaneous increase in donor life insurance gifts to universities and colleges and optimized excess returns on university and college endowment investment funds, comprises the steps of:

1) determining the required return on investment by the endowment investment funds;

2) selecting from among a database of prospective donor alumni of the universities and colleges a defined pool of insured donors based upon their age, health status, net worth, donative desire and intent, and other characteristics;

3) creating irrevocable life insurance trusts for each such selected donor;

4) appointing a trustee or trustees for such life insurance trusts

5) obtaining investment capital from the respective nonprofit endowment investment fund of the colleges and universities;

6) underwriting universal, variable universal, whole, term or other life insurance policies on each selected donor;

7) selecting the optimal policy to be underwritten from a variety of issuing insurers based upon the planned premium, guaranteed premium, length of guarantee, interest crediting rate, lapse rate subsidies, and other variables relevant to the overall economic performance of the policy in terms of the expected internal rate of return on the future death benefit;

8) using the capital obtained from the endowment investment funds to finance the initial premium payments and subsequent premiums, where necessary, on the selected donor policies;

9) splitting the insurance policy death benefits between the university or college and the endowment investment fund by naming both as beneficiaries of the irrevocable life insurance trust; and

10) optimizing the returns to the endowment investment funds versus the life insurance donations received by the university or colleges by allocating various percentages of the death benefit to be paid to the endowments investment funds or the university or college.

In an additional embodiment, a method for enabling donations of life insurance proceeds to a first entity is described, including the steps of: holding a life insurance policy on at least one donor in trust; financing the life insurance policy with funds from a second entity separate from the first entity; and establishing a distribution of proceeds from the life insurance policy to the first entity and the second entity.

In another additional embodiment, a method for enabling donations of life insurance proceeds to a non-profit entity is described, including the steps of: holding, for each of at least one donor, a life insurance policy on the donor in a trust; financing the life insurance policy with funds from a non-profit fund, the non-profit fund being separate from the non-profit entity; and establishing a distribution of proceeds from the life insurance policy to the non-profit entity and the non-profit fund.

In another additional embodiment, a method for enabling donations of life insurance proceeds by a donor to a beneficiary is described, including the steps of: purchasing an annuity with a loan; securing the loan with a first portion of proceeds from the life insurance policy; financing the loan and the life insurance policy with the annuity; and allocating a second portion of the proceeds from the life insurance policy to a beneficiary.

In another additional embodiment, a method for enabling donations of life insurance proceeds by a donor to a beneficiary, includes the steps of: supplying annuity payments to a life insurance trust, the life insurance trust holding a life insurance policy on a donor in trust and a loan on a death benefit of the life insurance policy, the life insurance trust using the annuity payments to finance the loan and the life insurance policy on the donor, a first portion of the death benefit being allocated to the loan and a second portion of the death benefit being allocated to the beneficiary; and receiving a lump sum consideration from the life insurance trust for the annuity payments equal to a principal amount of the loan.

In another additional embodiment, a method for enabling donations of life insurance proceeds by a donor to a beneficiary is described, including the steps of: determining a principal amount for a loan to a life insurance trust on a life insurance policy on the donor held by the life insurance trust, as a function of a death benefit of the life insurance policy; and defining a portion of the death benefit of the life insurance policy as collateral for the loan, to be allocated to the loan upon a death of the donor, another portion of the death benefit to be allocated to the beneficiary.

In another additional embodiment, a method for enabling donations of life insurance proceeds by a donor to a beneficiary, includes the step of insuring annuity payments purchased by a life insurance trust for a life of a donor with a loan secured by a first portion of a death benefit from a life insurance policy on the donor held by the life insurance trust in trust, the annuity payments financing the loan and the life insurance policy. In this embodiment, a second portion of the death benefit is allocated to a beneficiary upon death of the donor.

In another additional embodiment, a method for enabling donations of life insurance proceeds by a donor to a beneficiary is described, including the step of: investing in a lending entity that provides a loan to a life insurance trust collateralized with assets held by the life insurance trust, the assets including a first portion of proceeds on a life insurance policy on a donor held by the life insurance trust in trust, a second portion of the proceeds on the life insurance policy being designated as a donation to the beneficiary upon death of the donor; and investing in a reinsurance entity that provides insurance to an annuity paying entity on annuity payments supplied by the annuity paying entity to the life insurance trust for the life of the donor, the annuity payments financing the loan and the life insurance policy.

In another additional embodiment, a method for enabling donations of life insurance proceeds by a donor to a beneficiary is described, including the step of: investing in a lending entity that provides a loan to a life insurance trust for a purchase of an annuity, the loan being collateralized with assets held by the life insurance trust, the assets including a first portion of proceeds on a life insurance policy on a donor held by the life insurance trust in trust, a second portion of the proceeds on the life insurance policy being designated as a donation to the beneficiary upon death of the donor. The annuity payments from the annuity finance the loan and the life insurance policy.

In another additional embodiment, a method for enabling donations of life insurance proceeds by a donor to a beneficiary is described, including the step of: investing in a reinsurance entity that provides insurance to an annuity paying entity on annuity payments purchased by a life insurance trust for a lifetime of a donor, the life insurance trust purchasing the annuity payments with a loan taken by the life insurance trust, the loan being secured with a life insurance policy on the donor held by the life insurance trust in trust, the annuity payments financing the loan and the life insurance policy.

In another additional embodiment, a system enabling donations of life insurance proceeds to a non-profit entity is described, including a life insurance trust holding a life insurance policy on a life of a donor in trust, and a non-profit fund separate from the non-profit entity, the non-profit fund providing funds to the life insurance trust for financing the life insurance policy.

The life insurance trust establishes a distribution of proceeds from the life insurance policy to the non-profit entity and the non-profit fund.

In another additional embodiment, a system enabling donations of life insurance proceeds to a non-profit entity is described, including a life insurance trust holding in trust at least one life insurance policy on each of at least one donor to the non-profit entity, and a non-profit fund separate from the non-profit entity. The non-profit fund provides funds to the life insurance trust for financing each life insurance policy on each donor. The life insurance trust establishes a distribution of proceeds from each life insurance policy to the non-profit entity and the non-profit fund.

In another additional embodiment, a system enabling donations of life insurance proceeds to a non-profit entity is described, including a life insurance policy on a life of a donor, the life insurance policy being held in trust by a life insurance trust, and financed by the life insurance trust with funds provided to the life insurance trust from a non-profit fund separate from the non-profit entity. Proceeds from the life insurance policy are distributed by the life insurance trust to the non-profit entity and the non-profit fund.

In another additional embodiment, an investment vehicle in a non-profit investment fund supporting life insurance donations to a non-profit entity is described, the investment vehicle includes a tradable instrument providing investment capital to the non-profit investment fund, the non-profit investment fund being separate from the non-profit entity, funds from the non-profit investment fund being provided to a life insurance trust to finance a life insurance policy on a life of a donor. The life insurance trust holds the life insurance policy in trust and establishes a distribution of proceeds from the life insurance policy to the non-profit investment fund and the non-profit entity.

In another additional embodiment, a system enabling donations of life insurance proceeds to a beneficiary is described, including: a life insurance policy on a life of a donor, the life insurance policy being held in trust by a life insurance trust; a loan taken by the life insurance trust collateralized with the life insurance policy; and an annuity purchased by the life insurance trust with a principal amount of the loan, annuity payments from the annuity financing the loan and the life insurance policy. A first portion of a death benefit of the life insurance policy is allocated for the loan, and a second portion of the death benefit is allocated for donation to the beneficiary.

In another additional embodiment, an investment vehicle in an investment fund supporting life insurance donations to beneficiaries is described, the investment vehicle includes a tradable instrument providing investment capital to an investment fund, the investment fund investing the investment capital in a lending entity and a reinsurance entity. The lending entity provides a loan to a life insurance trust collateralized with a life insurance policy on a donor. The loan is provided for the life insurance trust to purchase annuity payments from an annuity paying entity. The life insurance policy is held by the life insurance trust in trust. A first portion of a death benefit of the life insurance policy is designated as collateral for the loan and a second portion of the death benefit is designated as a donation to a beneficiary. The reinsurance entity provides insurance to the annuity paying entity on the annuity payments purchased by the life insurance trust from the annuity paying entity. The annuity payments finance the loan and the life insurance policy.

In another additional embodiment, a debt investment vehicle to enable life insurance donations to beneficiaries is described, the debt investment vehicle including a loan to a borrower for a purchase of an annuity on a lifetime of a donor. The loan is secured by a life insurance policy on a donor. The life insurance policy is held by the borrower in a trust. The annuity finances the loan and the life insurance policy. A first portion of a death benefit of the life insurance policy is allocated to repay the loan, and a second portion of the death benefit is allocated for donation to a beneficiary.

In another additional embodiment, a system enabling life insurance donations to beneficiaries is described, the system including insurance on an annuity providing annuity payments to a life insurance trust for a life of a donor. The annuity is purchased by the life insurance trust with a loan on a life insurance policy on the life of the donor. The life insurance trust holds the life insurance policy in trust. The annuity payments cover interest on the loan and premiums on the life insurance policy. A first portion of a death benefit of the life insurance policy is assigned as collateral for the loan, and a second portion of the death benefit is allocated as a donation to a beneficiary.

In another additional embodiment, a system enabling donations of life insurance proceeds to a beneficiary is described, including: a life insurance trust holding a life insurance policy on a life of a donor in trust; a lending entity providing a loan to the life insurance trust on the life insurance policy; and an annuity paying entity providing annuity payments to the life insurance trust for the life of the donor in exchange for a principal amount of the loan. A first portion of a death benefit of the life insurance policy is assigned as collateral for the loan, and a second portion of the death benefit is allocated as a donation to a beneficiary. The annuity payments cover interest payments on the loan and premiums on the life insurance policy.

In another additional embodiment, a method for enabling donations of life insurance proceeds by a donor to a beneficiary is described, including the steps of: purchasing an annuity with a loan; securing the loan with a life insurance policy; financing the loan and the life insurance policy with the annuity; allocating a first portion of proceeds of the life insurance policy to repay the loan; and allocating a second portion of the proceeds of the life insurance policy to the beneficiary.

In another additional embodiment, a method for financing an annuity on a lifetime of a donor is described, including the steps of: offering a loan for purchasing the annuity, with requirements including a requirement that the loan be collateralized with a life insurance policy on the donor, and another requirement that the annuity be used to finance the loan and the life insurance policy, e.g., by covering interest payments on the loan and premiums on the life insurance policy.

### BRIEF DESCRIPTION OF THE DRAWINGS

FIG. 1 is a schematic representation of a system for enabling donations of life insurance proceeds to non-profit entities, such as university/college gift programs according to a first embodiment of the present invention.

FIG. 2 is a chart illustrating the analysis of a portfolio of life insurance policies for the system presented in FIG. 1.

FIG. 3 is a schematic representation of a system for enabling donations of life insurance proceeds to non-profit entities, such as university/college gift programs according to a second embodiment of the present invention.

### DETAILED DESCRIPTION

The present invention is described in relation to systems, methods, products and plans for the simultaneous enablement or facilitation of donations of life insurance proceeds to beneficiaries such as individuals, for-profit entities or nonprofit entities at no cost to the benefactors or donors, while enhancing the returns of the investment funds supporting such donations.

In a first embodiment of the present invention, systems, methods, products and plans for the simultaneous enablement or facilitation of donations of life insurance proceeds to donations to non-profit entities, such as colleges and universities, are described, although the description is applicable to other types of nonprofit entities or institutions, as well.

Colleges and universities are good candidates as non-profit entities that can benefit from the donation of life insurance proceeds according to the present invention for reasons not limited to the following:

1) Potential donor databases are naturally selected by age or mortality risk, e.g., most alumni fund raising is organized and targeted based upon year of graduation, thus providing a readily available cohort of donors that potentially would possess desirable life insurance underwriting criteria;

2) Potential donors are also naturally selected in terms of household income and net worth. For example, many graduates of the professional schools of ivy league universities have a high household net worth that would qualify for underwriting substantial amounts of life insurance on the donor graduate; and

3) Universities and colleges have long duration investment horizons. These long duration horizons are ideally suited to the duration profile of life insurance contracts; and

4) For the first embodiment of the present invention, universities and colleges have endowment investment funds that are separate nonprofit funds (or non-profit entities) from universities and colleges but related to the universities and colleges, providing funds to the universities and colleges. For example, a university fund management company is a distinct nonprofit entity from the university. Donors desire to make charitable gifts and donations to the universities and colleges, in many cases designating specific uses for the gifts, e.g., endowing a professorship in a certain academic department. Endowment investment funds, on the other hand, are often run by professional investment managers who use the same investment criteria and sophisticated risk management techniques as do other for-profit investment managers. The separation of governance and control of the two entities allows for the methods of the present invention to operate more efficiently. In particular, the methods and systems of the present invention optimally serve both distinct entities, in terms of providing superior investment performance to the endowment investment funds while also generating large donations to the colleges and universities themselves, at no cost to the donors;

5) Both the endowment investment funds and the universities and colleges have an insurable interest in their donor alumni and other benefactors. The insurable interest in one based upon the continued receipt and expectation of future donations and other types of institutional support (e.g., organizing other alumni charitable activities). This insurable interest is demonstrably stronger than that of most charitable institutions; and

6) Additionally, unlike other charitable institutions, the endowment investment funds can provide an accessible source of capital to purchase life insurance policies as set forth in more detail below.

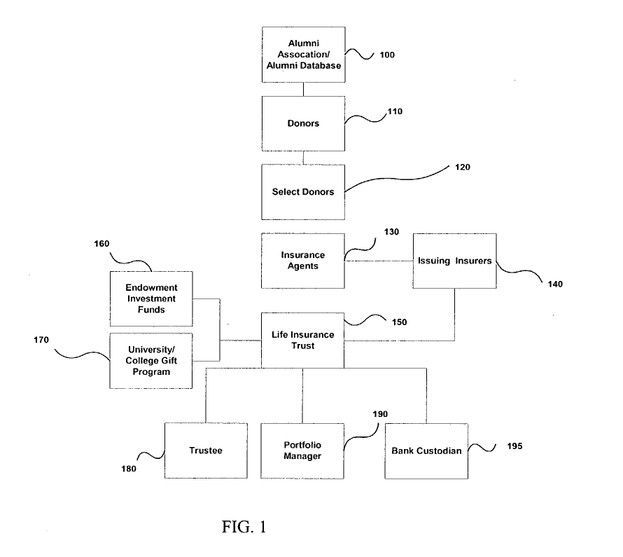

FIG. 1 is a schematic representation of a system for creating simultaneous excess risk adjusted returns for university and college endowment investments funds and substantial donations to the gift programs of such colleges and universities without cost to the donors according to a first embodiment of the present invention. The system may comprise an university or college alumni database, 100, a cohort of potential donors 110, a cohort of select donors 120, participating insurance agents 130, issuing life insurers 140, life insurance trust 150, endowment investment funds 160, gift programs 170, life insurance trust trustee 180, portfolio manager 190, and bank custodian 195. As illustrated in FIG. 1, various parts of the system may interact with other parts of the system via exchange of information and cashflows pursuant to financial transactions.

In this embodiment, alumni database component 100 is obtained from university and college alumni associations. The database is searched initially for a cohort of potential donors 110. For example, all donor alumni graduating in the year 1955 and earlier might be searched and compiled into a list of potential donors 110.

The universe of potential donors 110 is then filtered by select underwriting criteria to form a list of select donors 120. Such criteria, can include age, health status, sex, occupation, employment status, household income and net worth, country of origin, current location of residence, and other criteria. For example, as described more fully below, select donors 120 can comprise alumni males age 75 and older (80 and older for females) who each have a net worth of at least 1 million dollars. Additionally, the amount of insurance currently held by the select donors 120 could be required, such that an additional amount of permanent or term life insurance in amounts exceeding, for example, US$500,000 would be available for underwriting, given the donor's age, health status, and net worth.

A list of select donors 120, is then made available to insurance agents 130. The insurance agents: (1) contact the select donors; (2) obtain necessary medical information regarding the select donors; and (3) process life insurance applications on the select donors for universal, whole, variable universal, or term life insurance. The insurance agents 130 seek to find the most attractive, e.g., the lowest premium rates, for a given death benefit for a select donor 120. Finding the lowest premium rates for a given death benefit may require the insurance agent to make inquiries to multiple life insurance companies to determine which companies will be the issuing insurers 140.

In one embodiment, the majority of policies to be underwritten on the select donors 120 are universal life (UL) policies. Such UL policies allow for flexible premium payment schedules and the ability to also flexibly alter the amount of coverage. In addition, UL policies can have generous interest rates which apply to premium balances in excess of those minimally required to prevent the policy from lapsing. UL policies also provide the ability to pay a target to planned premium or a guaranteed premium. The planned premium is the premium paid periodically, which given current forecasts of mortality charges, will keep the policy in force until the policy maturity date—which may be either the date of death or age 100 or 120. The guaranteed premium is the premium which can be paid that will guarantee that the policy will not lapse even if higher than expected mortality charges occur. Finally and as described in more detail below, competitive underwriting pressures for UL policies across different issuing insurers may allow select donors 120 to obtain favorable expected costs of insurance.

Life insurers 140 comprise the insurance companies which underwrite or issue universal, whole, variable, universal, or term life insurance on the lives of the select donors 120. Insurance agents 130 will have established relationships with the life insurers 140 that possess adequate credit ratings, such as a rating of A or better by A. M. Best, Standard and Poor's, Moodys, Fitch or other similar rating agencies.

Life insurance trust 150 can be an Irrevocable Life Insurance Trust or ILIT, to be settled by each respective grantor (or settlor) of select donor 120. The select donor 120 is the grantor of the trust and irrevocably gives up all rights to the trust assets. One consequence of life insurance trust 150's construction as an ILIT is the ability to minimize or eliminate any estate tax consequences of the assets held in trust. Each select donor 120 is the insured of his respective ILIT 155. Each ILIT 155 has a trust indenture or trust agreement, which enumerates the purposes of the trust, the property held by the trust, the trust beneficiaries, and how the trust property is to be distributed.

Each ILIT 155, will contain one or more insurance policies contracted by insurance agents 130, on the life of the select donor 120. As indicated previously and as described in more detail below, the majority of life insurance policies on the life of each respective select donor 120 in the ILIT 155 may be universal life policies. Other policy types, however, such as second-to-die, may be included.

The trust agreement for the ILIT 155, will name at least two or three irrevocable beneficiaries. In other embodiments, different numbers of beneficiaries may be named. In this embodiment both the endowment investment fund 160, and the gift program of the respective university or college 170 are named as irrevocable beneficiaries of the ILIT 155. For example, University X Management Company, the endowment investment fund which manages the investments of University X, would be named as a irrevocable beneficiary of ILIT 155, as well as the gift program of University X. Since both are nonprofit institutions, they will either be exempted from the insurable interest requirements of many states (e.g., New York Insurance Laws Section 3205(a)(3)) or will naturally be deemed to have an insurable interest in the select donor alumnus whose life is being insured.

Alternatively in other embodiments, the beneficiaries may be revocable as well as irrevocable. A beneficiary which is irrevocable has a stronger property right in the trust assets and, for example, must provide consent to such matters as changing the trust agreement, changing the beneficiary, distribution of trust assets not in accordance with the trust document, and other such matters.

The endowment investment funds 160 finance the purchase of the life insurance policies through insurance agents 130 from issuing insurers 140 by paying the periodic premiums required to maintain the policy in force. Such premiums are referred to as “no lapse” premiums or target premiums. As indicated above, universal life insurance policies allow great flexibility as to the size and timing of the minimum premiums required to keep the policy from lapsing. The trustee 180 of ILIT 155 is appointed to enforce the trust document and represent the interests of the beneficiaries. Some of the duties of the trustee include, but are not limited to: (1) opening a bank account with bank custodian 195 for the purpose of depositing cash received from endowment investment funds 160, and paying premiums to the issuing insurers 140; (2) collecting death benefits upon the death of the insured from the issuing insurers 140; and (3) disbursing the death benefits to the respective beneficiaries.

In consultation with the endowment investment fund 160, the university or college gift program 170 and the select donor 120, the portfolio manager 190 will advise on the type of life insurance policy to be purchased and the method of splitting the death benefit among the endowment investment fund 160, and the university or college gift program 170. In this embodiment, the goal is to split the death benefits between the endowment investment fund 160 and the university or college gift program 170 in such manner so as to provide: (1) significant incentives for the select donors 120 to participate in the plan by making available large life insurance gifts in their name; and (2) providing excess risk adjusted returns to the endowment investment funds 160 on a portfolio of life insurance policies on select donors 120 in which they have invested the premiums. For example, the portfolio manager 190 might determine, using methods described in detail below, that for an insurance policy with a $10 million death benefit, $2 million should go to the university or college gift program 170 for the first 5 years, $1 million for the next five years, and $500,000 thereafter. The remainder of the death benefit reverts to the endowment investment fund 160 to provide, on a portfolio of such policies, a risk adjusted excess return on its investment capital. Once the portfolio manager 190 and the beneficiaries have decided the optimal combination of donations and returns, the split of the death benefit of the policy between the beneficiaries is incorporated into the trust document of the ILIT 155.

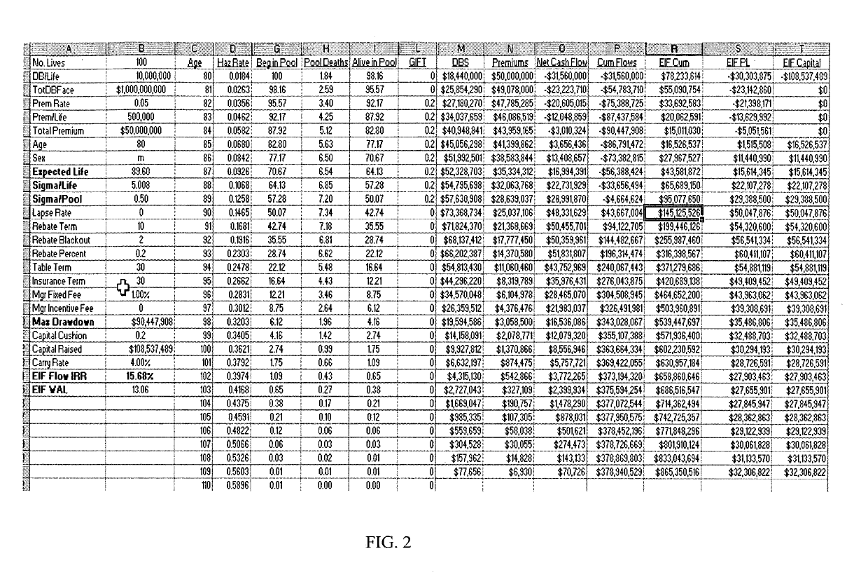

FIG. 2 is a spreadsheet chart illustrating the investment analysis of the portfolio manager 190. The chart illustrates both the parameter inputs and parameter outputs, which are relevant to the portfolio manager 190 in determining the required rate of return to the endowment investment fund 160 (EIF) and the donee university or college gift program 170 (GIFT).

Column A of FIG. 2 illustrates these parameters which include, but are not limited to: (1) the number of lives to be insured (B1); (2) the average death benefit per life (B2); (3) the total death benefit for all of the insured lives (B3); (4) the target premium rate (B4) expressed as a percentage of the death benefit per life (B2); (5) the annual target premium per select donor life (B5) which is equal to the product of the target premium rate (B4) multiplied by the death benefit per life (B2); (6) the total initial target premium (B6) which is equal to the product of the annual target premium per select donor life (B5) and the number of select donor lives insured (B1); (7) the average age of the select donor 120 (B7); (8) the sex of the select donor lives under analysis (B8); (9) the calculated expected life span of the select donor life (B9) using mortality data such as the recently approved 2001 Commissioners Standard Ordinary (CSO) Male NonSmoker Select Tables; (10) the calculated standard deviation for each representative donor life (B10); (11) the standard error around the mean donor life expectancy for the entire pool (B11) which is equal to the standard deviation per select donor life (B10) divided by the number of select donors to be insured (B1); (12) the number of policies which will be allowed to lapse per year and will not be kept in force (B12) (in one embodiment, the lower the lapse rate, the higher the expected rate of return to the EIF); (13) the number of years during which the select donor's portion of the death benefit will be paid to the university or college of the select donor's choice (B13); (14) the number of initial years during which no benefit will be paid to the university or college, which in one embodiment, will be set at two years so as to correspond to standard no contestability clauses found in life insurance contracts; (15) the percentage of the total death benefit per select donor 120 (B2) which is to be donated to the university or college beneficiary selected by the donor 120 (B15); (16) the maximum age to which the mortality table being extends, in years, from the average age of the insured select donor (B16); (17) the average term of the insurance policy purchased during which a death benefit will be paid (B 17); (18) the fee paid to the portfolio manager 190 as a fixed percentage of assets invested by the EIF; (19) the fee paid to the portfolio manager as a fixed percentage of profits, which can be set at zero (B19); (20) the expected net funding requirement needed in the first several years of the plan of the present invention for premium payment to maintain the life insurance policies on the select donors in force (B20); (21) the amount of capital to be raised in excess of the expected net 120 funding requirement as a percentage increase of the net funding requirement (B21); (22) the capital requirement to be invested by the EIF 160 (B22) which is one plus the “capital cushion” of (B21) multiplied by the net expected funding requirement of (B20); (23) the minimum rate of interest to be applied to excess capital not invested in the life insurance policies (B23); (24) the calculated internal rate of return on invested capital to the EIF 160 net of fees for the portfolio manager 190 (B24) and; (25) the calculated weighted average life of the investment to the EIF 160 in years (B25).

The analysis of the portfolio manager 190 will also include relevant mortality data. For example, column D of FIG. 2 contains actuarial hazard rates for an 80 year old male nonsmoker from the 2001 CSO Select table. An actuarial hazard rate measures the rate at which remaining lives of a cohort die in a given year. Columns G, H, and I of FIG. 2 apply these hazard rates to the select donor pool of 100 lives (B 1). For example, after 2 years, when the males originally age 80 are now aged 82, on average 4.43 deaths would have occurred leaving only 95.57 select donors on average alive out per 100 select donors originally in the plan. Other mortality data may be used as is relevant. Such data may be obtained from websites or a variety of other sources.

Referring again to FIG. 2, column M computes the death benefits (assumed payable at the end of the year) given the number of statistical deaths contained in column H. Each row of column M is therefore equal to the product of the respective row in column H multiplied by the death benefit per life contained in (B2). Column N contains the premium payments required to be made to keep the life insurance policies in force for those select donors 120 still alive at the beginning of the year indicated in Column C. For example, cell (N3) indicates a required premium of $49,078,000 which is the product of the number of select donors 120 alive at the beginning of the year on average (equal to 98.16 in cell (G3)) multiplied by the annual premium per select donor 120 (B5).

Column O contains the Net Cash Flows for each year which are equal to the respective death benefits of Column M less the premium outlays of Column N. As can be seen from FIG. 2, in the early years of the plan of the present invention, the net cash flows are negative meaning that more premiums must be paid than death benefits are received.

Column P of FIG. 2, contains the cumulative net cash flows, which is a running sum of Column O. As can be seen, the minimum of Column P is equal to −$90,447,908 which is equal to the maximum drawdown or expected net funding requirement of cell (B20) from which the required investment capital of the EIF 160 is computed. Column R contains a cumulative total of the investment account of the EIF 160 assuming the capital investment of cell (B22) is used and the net cash flows of Column O. Column S shows the profit and loss for each year to the EIF 160 assuming the interest rate of (B23) on uninvested balances and net of the management fees of (B 18) and (B 19). Finally, Column T shows the capital account of the EIF 160 from which investment returns are computed. As can be seen from (T2), the EIF 160 first makes an upfront investment of $108,537,489 as is shown in (B22). While the net cash flows in column O are negative, the EIF 160 receives no return on capital. As soon as the net cash flows in column O are positive, the EIF 160 receives its portion of such cash flows net of any portfolio manager fees plus an uninvested balances which have been invested at the interest rate of (B23). Other embodiments for computing the returns on EIF capital are possible.

The internal rate of return on the cash flows contains in column T are then computed by the portfolio manger using standard techniques. The internal rate of return is reported in (B24). Additionally, the portfolio manager 160 may compute, a measure of the duration of the returns to be obtained from the life insurance investments.

One such measure is known as the Weighted Average Life, or WAL, as is reported in (B25). The units of WAL are in years which give a relative indication of the investment horizon of a given investment. Investments in life insurance policies on select donors 120 may have WAL's which range from 5-20 years, though shorter or longer WAL's are possible.

After the portfolio manager 190 has performed the calculations as illustrated in FIG. 2, (s)he may then vary certain parameters to determine their influence on: (1) the amount of life insurance that can be donated to the college or university gift program 170; (2) the returns on capital invested by the endowment investment funds 160; (3) the weighted average life of the investment. For example, increasing the term or the size of the life insurance donation of which the university or college is a beneficiary will both reduce the rate of return on capital to the EIF 160 and extend the WAL of the investment. The portfolio manager 190 may also investigate the effect of lower premium rates on EIF 160 returns on investment, for example, and may decide to make inquiries of additional insurance companies for the purpose of receiving a more favorable premium for the same death benefit. Other variations of the parameters are possible in order to obtain a simultaneous amount of life insurance to be donated by the select donor 120 and the required return on investment capital for the EIF 160 which make both beneficiaries eager participants of the plan of the present invention.

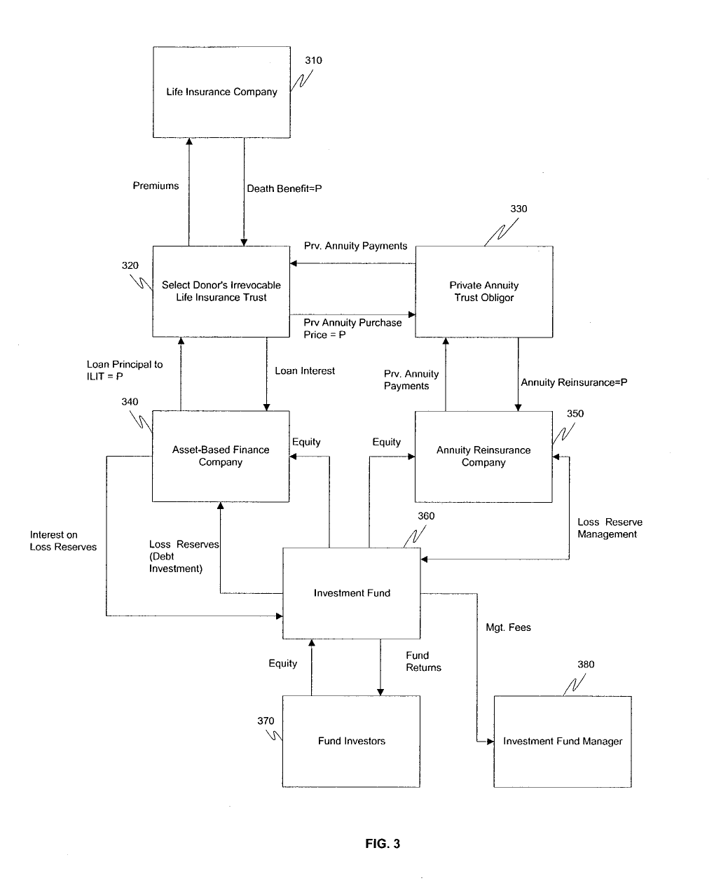

In an alternative embodiment of investor financing of insurance for select donors and their respective beneficiaries, FIG. 3 illustrates a system and method in which a private annuity and a mortality linked loan are used to finance the select donor's insurance trust. FIG. 3 also illustrates from a different point of view, a system and method in which an annuity, such as a private annuity, is purchased with a loan, such as a mortality-linked loan, and the loan is secured or collateralized with the life insurance policies of select donors. Annuity payments are used by the insurance trust to finance the loan and the life insurance policies. Upon death of a select donor, a first portion of the proceeds or death benefit of the life insurance policy is allocated to the loan, and a second portion of the proceeds or death benefit is allocated for donation to the beneficiary. The beneficiary can be selected or designated by the donor or the life insurance trust, and can be an individual, or a for-profit or non-profit entity or institution.

Referring to FIG. 3, the system contains a life insurance 310, the select donor's insurance trust 320, a private annuity trust obligor 330, an asset-based finance company 340, an annuity reinsurance company 350, an investment fund 360, fund

investors 370, and investment fund manager 380. In contrast to the embodiment illustrated in FIGS. 1 and 2, in which an endowment investment fund 160 makes a direct investment into the select donor's 120 insurance trust 150, the system and method of FIG. 3 has a lending institution or asset-based finance company 340 make a loan on the life insurance policy, for a principal amount equal to the amount of the insurance death benefit to the select donor's life insurance trust 320. The loan agreement provides for a collateral schedule whereby the finance company 340 takes a collateral assignment in the assets of the life insurance trust 320, including any death benefits paid under any insurance policies. The collateral schedule may specify, for example, that 80% of specified insurance policies be used to collateralize the loan made by the finance company 340 to the insurance trust 320 for the first 5 years. After 5 years, for example, the collateral required and assigned may increase to 90% or higher. As part of the loan agreement between the insurance trust 320 and the asset-based finance company 340 the insurance trust 320 agrees to make periodic interest payments (e.g., annually) to the finance company 340.

The life insurance trust 320 uses the loan proceeds from asset-based finance company 340 to purchase a private annuity on the life of the select donor (shown as 120 in FIG. 1) from a private annuity trust obligor 330. A private annuity trust obligor 330 is a trust which promises to make annuity payments to an annuitant usually in exchange for a lump sum consideration of cash or other assets. The arrangement is referred to as a private annuity. The annuity is “private” as distinguished from annuities sold by life insurance companies since the entity issuing the annuity is not usually in the business of selling large amounts of annuity contracts. The private annuity trust obligor 330 promises to make periodic payments (e.g., annual) to the select donor's life insurance trust 320 as long as the select donor is alive, in exchange for a lump sum consideration. In this embodiment, the purchase price is equal to the loan principal amount which the finance company 340 loaned to the insurance trust 320. As part of the previously mentioned loan agreement between the asset-based finance company 340 and the select donor's insurance trust 320, the insurance trust 320 uses the annuity payments received from the private annuity trust obligor 330 to both pay the interest to the asset-based finance company 340 and also to purchase a term, whole, universal, universal variable or other life insurance policy on the life of the select donor with death benefit equal to the loan amount from the asset-based finance company 340. The life insurance company 310 receives the premiums from the select donor insurance trust 320 and pays the death benefit to the select donor insurance trust 320 upon the death of the select donor. As indicated above, a portion of the death benefit may have been assigned to collateralize the loan from the asset-based finance company 340 to the insurance trust 320, e.g., 90%. The remainder of the death benefit is paid to the beneficiary of the select donor's choice, such as the university or college from which the select donor graduated (shown as 170 in FIG. 1). Other beneficiaries may receive the balance of such death benefits.

In this embodiment, the private annuity trust obligor 330 will desire to insure the risk of the annuity on the life of the select donor with an annuity reinsurance company 350. The private annuity trust obligor 330 will purchase reinsurance with a lump sum, which can be equal to the fair cost of the annuity on the life of the select donor, and in exchange will receive the annuity payments from the annuity reinsurance company 350 which the private annuity trust obligor 330 has promised to the select donor's insurance trust 320.

Annuity reinsurance company 350 will then have assets equal to the purchase prices of all of the annuities it has reinsured from all respective private annuity trust obligors 330. These assets can be invested in an investment fund 360. The annuity reinsurance company 350 will receive a rate of return on its invested assets and will be able to draw upon its investment account with investment fund 360 in order to make the promised annuity reinsurance payments to the private annuity trust obligor 330. The annuity reinsurance company 350 will also use the investment fund 360 to manage the loss reserves on the annuities it has reinsured. The investment fund 360, in turn, may invest the interest on the loss reserves and/or invest the loss reserves as a debt investment in the annuity-based finance company 340.

Additionally, investment fund 360 receives equity investment from fund investors 370. The investment fund 360 may be a for-profit investment fund (as opposed to the non-profit endowment investment fund 160 illustrated in FIG. 1). The investors, can be university or college endowment investment funds. Investment fund 360 is managed by investment fund manager 380 in exchange for fund management fees. The investment fund manager 380 oversees all of the investments of the investment fund 360, and monitors them for adequacy of return given the amount of risk entailed by the fund's investments.

In this embodiment, the investment fund 360 may make loans or other debt investments or equity investments in the asset-based finance company 340 so that the asset-based finance company 340 then has capital to make additional loans to additional select donor insurance trusts in order to finance additional donor insurance policies. The investment fund 360 will receive a rate of return on its investment in the asset-based finance company 340. Similarly, the investment fund 360 may invest (debt or equity) in the annuity reinsurance company 350, in addition to managing the loss reserves from the annuity reinsurance company 350.

In the embodiments shown in FIGS. 1 to 3, the superior risk adjusted investment returns received by the EIF of the first embodiment or the investment fund of the second embodiment derive from the unique portfolio management techniques and portfolio composition characteristics of the present invention. In particular, these techniques and characteristics include, but are not limited to:

(1) Lapse Rate Arbitrage Opportunities: The pricing of insurance policies inherently involves the pooling of risks which are not identical. Underwriting risk classification aims to make these risks within a class as homogenous as possible so that each risk class can be discriminated by price. Nevertheless, there inevitably remains cross-subsidies in insurance, whether from good risk to bad risk (adverse selection) or intentional use of subsidies to price policies in order to attract additional underwriting business. For example, insurance companies may subsidize the underwriting of older insureds who desire large policies at substantial premiums in order to attract the business away from competitors. One mechanism of subsidy is to provide lower pricing to a group of insured based upon an estimate that a percentage of the group will lapse their policies over time, i.e., that premiums will be paid for some number of months or years, but that, prior to death, the policy will be surrendered or lapses. When a policy lapses, the insured pays no further premiums, forfeits all future benefits under the policy including the death benefit, and may obtain a cash surrender value from the company. Typically, the insurance company will have obtained the use of the premium funds from lapses policies at very low cost since the insurer will never be obligated to pay death benefits on the lapsed policies. Some insurers can then pass on the savings from lapses policies to the group as a whole in terms of lower premium charges. In the first and second embodiment of this invention, the group of select donors participating will have life insurance policies that are funded to maturity, i.e., no donor policies will be surrendered or lapsed. These policies as a group therefore take advantage of the lapse rate subsidy provided to the group as a whole which increased the returns to the EIF of FIG. 1 or the investment fund of FIG. 3.

(2) Leverage on Invested Assets: Another source of economic benefit to the methods and systems of the present invention is the natural increase in returns due to financing future premium payments on a portfolio of select donor life insurance with the death benefits from select donors in the portfolio that have died. Early death benefits therefore provide an additional form of continuing financing for ongoing premium obligations for select donors in the program who are still alive. The additional financing in the form of death benefits boosts the returns to the capital invested by the EIF of FIG. 1 or the investment fund making loans to purchase annuities which fund the life insurance policies in FIG. 3.

(3) Real and Financial Policy Options: Many types of life insurance policies, in particular universal life insurance, have a variety of embedded contract terms which can be optimally used by the owner of the policy to increase the expected value of the policy to the owner or the entity financing the policy. For example, most universal life policies provide for minimum interest rates at which account values are credited. These typically exceed short term interest rates in the capital markets and can be used by the owner of the policy in a variety of ways to increase returns on the policy. For example, the owner may use the floor or minimum interest rate provided by the policy by investing excess funds in the policy and then selling an interest rate floor in the capital markets, such as eurodollar floor in the Chicago Mercantile Exchange. As an additional example, most universal life policies allow premium payments on a flexible schedule as long as monthly mortality deductions are covered. Typically, the monthly mortality charges are quite low in the early years and then grow in the later years. However, the mortality charges are typically lower than the annual death rates in the later years. By paying the minimum mortality charges in the earlier years and more than a flat premium in the later years, a greater return on capital can be achieved in a preferred embodiment. Other types of options embedded in universal life and other life insurance policies can be optimally managed in order to extract additional returns on investor capital.

In the preceding specification, the present invention has been described with reference to specific exemplary embodiments thereof. Although many steps have been conveniently illustrated as described in a sequential manner, it will be appreciated that steps may be reordered or performed in parallel. It will further be evident that various modifications and changes may be made therewith without departing from the broader spirit and scope of the present invention as set forth in the claims that follow. The description and drawings are accordingly to be regarded in an illustrative rather than a restrictive sense.

What is claimed is:

1. A method for enabling donations of life insurance proceeds to a first entity, comprising the steps of:
holding a life insurance policy on at least one donor in trust;
financing the life insurance policy with funds from a second entity separate from the first entity; and
establishing a distribution of proceeds from the life insurance policy to the first entity and the second entity.

2. A method for enabling donations of life insurance proceeds to a non-profit entity, comprising the steps of:
holding, for each of at least one donor, a life insurance policy on the donor in a trust;
financing the life insurance policy with funds from a non-profit fund, the non-profit fund being separate from the non-profit entity; and
establishing a distribution of proceeds from the life insurance policy to the non-profit entity and the non-profit fund.

3. The method according to claim 2, further comprising the step of:
distributing the proceeds from the life insurance policy to the non-profit entity and the non-profit fund.

4. The method according to claim 3, wherein the distributing step includes the step of:
distributing death benefits from the life insurance policy to the non-profit entity and the non-profit fund, the distributed proceeds being the death benefits from the life insurance policy.

5. The method according to claim 4, wherein the establishing step includes the step of:
establishing a distribution of the death benefits from the life insurance policy to the non-profit entity and the non-profit fund.

6. The method according to claim 2, further comprising the step of:
selecting at least one donor as a function of at least one underwriting characteristic of each prospective donor in a set including at least one prospective donor.

7. The method according to claim 2, further comprising the step of:
selecting at least one donor from a prospective donor set including at least one prospective donor, as a function of at least one characteristic of each of the at least one prospective donor.

8. The method according to claim 7, wherein the selecting step includes the step of:
selecting donors from a database storing information related to the at least one characteristic of each prospective donor in the prospective donor set, the at least one characteristic including at least one of an age, sex, occupation, employment status, health status, household income, net worth, country of origin, current location of residence, donative desire, donative intent, and current amount of insurance held by the prospective donor.

9. The method according to claim 7, further comprising the step of:
generating a prospective donor set including at least one prospective donor.

10. The method according to claim 9, wherein the generating step includes the step of:
searching an alumni database for prospective donors.

11. The method according to claim 10, wherein the searching step includes the step of:
searching the alumni database by graduating year of the alumni of one of a university and a college.

12. The method according to claim 11, further comprising the step of:
selecting one of a university and a college as the non-profit entity.

13. The method according to claim 2, further comprising the step of:
generating a select donor list, the select donor list including the at least one donor.

14. The method according to claim 13, further comprising the step of:
providing the select donor list to an insurance agent.

15. The method according to claim 13, further comprising the step of:
processing life insurance applications on each select donor in the select donor list.

16. The method according to claim 15, wherein the processing step includes the step of:
obtaining information from each select donor necessary to complete the life insurance application for the select donor.

17. The method according to claim 15, wherein the processing step includes the step of:
selecting a type of life insurance policy for each select donor, wherein the type of life insurance policy includes one of a universal life insurance policy, a whole life insurance policy, a variable universal life insurance policy and a term life insurance policy.

18. The method according to claim 15, wherein the processing step includes the step of:
selecting a universal life insurance policy as the life insurance policy.

19. The method according to claim 13, further comprising the step of:
submitting a life insurance application on each select donor in the select donor list.

20. The method according to claim 13, further comprising the step of:
selecting a life insurance company to provide life insurance for a select donor as a function of at least one criterion of the life insurance company.

21. The method according to claim 20, wherein the step of selecting the life insurance company includes the step of:
selecting the life insurance company as a function of at least one of a credit rating of the life insurance company, and a premium and a death benefit of a life insurance policy offered by the life insurance company for the select donor.

22. The method according to claim 20, wherein the step of selecting the life insurance company includes the step of:
selecting the life insurance company from a plurality of life insurance companies.

23. The method according to claim 2, further comprising the step of:
selecting an optimal policy as the life insurance policy for the donor as a function of at least one variable relevant to an overall economic performance of the life insurance policy.

24. The method according to claim 23, further comprising the step of:
determining an expected internal rate of return on a future death benefit of the life insurance policy, as an indication of the overall economic performance of the life insurance policy.

25. The method according to claim 23, further comprising the step of:
selecting the optimal policy as the life insurance policy, from a plurality of possible life insurance policies offered by a plurality of issuing issuers, as a function of at least one of a planned premium, guaranteed premium, length of guarantee, interest crediting rate, lapse rate subsidies offered by each issuing issuer on a possible life insurance policy.

26. The method according to claim 2, further comprising the step of:
underwriting the life insurance policy on the donor.

27. The method according to claim 2, wherein the financing step includes the step of:
financing the life insurance policy with funds from an endowment investment fund related to and separate from the non-profit entity.

28. The method according to claim 2, further comprising the step of:
selecting at least one of a university and a college as the non-profit entity.

29. The method according to claim 27, wherein the financing step includes the step of:
obtaining investment capital from the endowment investment fund, the funds financing the life insurance policy being the obtained investment capital.

30. The method according to claim 29, wherein the financing step includes the step of:
financing an initial premium and subsequent premiums on the life insurance policy with the investment capital from the endowment investment fund.

31. The method according to claim 29, wherein the financing step includes the step of:
maintaining the life insurance policy in force.

32. The method according to claim 31, wherein the maintaining step includes the step of:
paying periodic premiums on the life insurance policy with investment capital from the endowment investment fund.

33. The method according to claim 32, further comprising the step of:
opening a bank account with a bank custodian, in which the investment capital is deposited, and from which the periodic premiums are paid.

34. The method according to claim 29, wherein the establishing step includes the step of:
determining a required return on the investment capital from the endowment investment fund.

35. The method according to claim 2, wherein the establishing step includes the step of:
optimizing a return on funds from the non-profit entity and a donation by the at least one donor to the non-profit institution.

36. The method according to claim 2, further comprising the step of:
providing the non-profit entity with an excess risk adjusted return on the funds financing the life insurance policy and at least one additional life insurance policy.

37. The method according to claim 2, further comprising the step of:
selecting the life insurance policy.

38. The method according to claim 37, further comprising the step of:
receiving advice from a portfolio manager on the selection of the life insurance policy and the distribution of the proceeds.

39. The method according to claim 2, further comprising the step of:
incorporating the distribution of the proceeds into a trust document of the trust.

40. The method according to claim 2, further comprising the step of:
naming the non-profit entity and the non-profit fund as beneficiaries of the trust.

41. The method according to claim 2, wherein the holding step includes the step of:
holding a life insurance policy on at least one donor in an irrevocable life insurance trust, the trust being the irrevocable life insurance trust.

42. The method according to claim 2, further comprising the step of:
appointing a trustee for the trust.

43. The method according to claim 42, wherein the appointing step includes the step of:
appointing the trustee to enforce a trust agreement for the trust and represent beneficiaries of the trust, the beneficiaries including the non-profit entity and the non-profit fund.

44. The method according to claim 2, further comprising the step of:
effecting, for each of the at least one donor, a grant of the trust by the donor on the life insurance policy to a life insurance trust.

45. The method according to claim 44, wherein the effecting step includes the step of:
effecting, for each of the at least one donor, a grant of an irrevocable trust by the donor on the life insurance policy to the life insurance trust.

46. The method according to claim 44, further comprising the step of:
selecting the life insurance trust.

47. The method according to claim 46, wherein the step of selecting the life insurance trust includes the step of:
selecting an irrevocable life insurance trust as the life insurance trust.

48. The method according to claim 44, wherein the holding step includes the step of:
designating the donor as an insured of the life insurance trust.

49. The method according to claim 44, further comprising the step of:
setting forth purposes of the trust, identification of the life insurance policy as the property of the trust, beneficiaries of the trust, and the distribution in one of a trust indenture and trust agreement for the life insurance trust.

50. The method according to claim 2, wherein the holding step includes the step of:
holding, for each of the at least one donor, at least one life insurance policy on the donor in the trust.

51. The method according to claim 50, wherein the holding step includes the step of:
holding, for each of the at least one donor, a universal life insurance policy and a second-to-die life insurance policy on the donor in the trust.

52. A method for enabling donations of life insurance proceeds by a donor to a beneficiary, comprising the steps of:
purchasing an annuity with a loan;
securing the loan with a first portion of proceeds from the life insurance policy;
financing the loan and the life insurance policy with the annuity; and
allocating a second portion of the proceeds from the life insurance policy to a beneficiary.

53. The method according to claim 52, further comprising the step of:
identifying a for-profit entity as the beneficiary.

54. The method according to claim 52, further comprising the step of:
identifying a non-profit entity as the beneficiary.

55. The method according to claim 52, further comprising the step of:
defining a first quantity of a death benefit of the life insurance policy as the first portion of the proceeds, and a second quantity of the death benefit as the second portion of the proceeds.

56. The method according to claim 52, further comprising the step of:
holding the life insurance policy on a donor in a trust.

57. The method according to claim 56, wherein the allocating step includes the step of:
allocating the second portion of the proceeds to the beneficiary selected by the donor.

58. The method according to claim 56, further comprising the step of:
accepting a mortality-linked loan to purchase the annuity, the mortality-linked loan being linked to a life of the donor.

59. The method according to claim 58, wherein the purchasing step includes the step of:
purchasing a private annuity with the mortality-linked loan.

60. The method according to claim 56, wherein the securing step includes the step of:
collateralizing the loan with assets in the trust, the assets including the life insurance policy.

61. The method according to claim 56, further comprising the step of:
accepting a loan for a principal amount.

62. The method according to claim 61, wherein the purchasing step includes the step of:
purchasing the annuity with the principal amount of the loan.

63. The method according to claim 62, wherein the step of purchasing the annuity with the principal amount of the loan includes the step of:
receiving annuity payments in exchange for the principal amount of the loan.

64. The method according to claim 63, wherein the financing step includes the step of:
financing the loan and the life insurance policy with the annuity payments.

65. The method according to claim 56, further comprising the step of:
accepting the loan from one of a lending institution and an asset-based finance company.

66. The method according to claim 65, wherein the accepting step includes the step of:
accepting a principal amount of the loan equal to a death benefit of the life insurance policy on the donor.

67. The method according to claim 56, wherein the financing step includes the step of:
paying interest on the loan with a first portion of annuity payments from the annuity.

68. The method according to claim 67, wherein the accepting step includes the step of:
setting forth an interest payment schedule in a loan agreement between the trust and an asset-based finance company providing the loan to the trust.

69. The method according to claim 65, wherein the step of accepting the loan from one of the lending institution and the asset-based finance company includes the step of:
accepting the loan from the asset-based finance company, an investment fund investing in the asset-based finance company.

70. The method according to claim 56, further comprising the step of:
receiving annuity payments for a duration of a life of the donor in exchange for a lump sum consideration equal to a principal amount of the loan.

71. The method according to claim 70, wherein the receiving step includes the step of:
receiving the annuity payments from a private annuity trust obligor.

72. The method according to claim 56, wherein the purchasing step includes the step of:
receiving insured annuity payments in exchange for a principal amount of the loan.

73. The method according to claim 72, wherein the step of receiving the insured annuity payments, includes the step of:
receiving the insured annuity payments from a private annuity trust obligor, the insured annuity payments being supplied to the private annuity obligor by an annuity reinsurance company in exchange for an insurance purchase price paid by the private annuity obligor to the annuity reinsurance company.

74. The method according to claim 73, wherein the step of receiving the insured annuity payments from the private annuity trust obligor, includes the step of:
receiving the insured annuity payments from the private annuity trust obligor, the insured annuity payments being supplied to the private annuity obligor by an annuity reinsurance company in exchange for an insurance purchase price paid by the private annuity obligor to the annuity reinsurance company, an investment fund investing in the annuity reinsurance company.

75. The method according to claim 52, further comprising the step of:
selecting one of a term life insurance policy, whole life insurance policy, universal life insurance policy and a universal variable life insurance policy as the life insurance policy.

76. The method according to claim 52, further comprising the step of:
purchasing the life insurance policy on a donor from a life insurance company with a portion of annuity payments from the annuity.

77. The method according to claim 76, further comprising the step of:
distributing, upon death of the donor, a first quantity of a death benefit of the life insurance policy to the loan and a second quantity of the death benefit to the beneficiary, the first quantity being the first portion securing the loan, and the second quantity being the second portion allocated to the beneficiary.

78. The method according to claim 77, wherein the distributing step includes the step of:
repaying the principal amount of the loan with the first quantity of the death benefit.

79. The method according to claim 77, further comprising the step of:
selecting a non-profit entity as the beneficiary.

80. The method according to claim 79, wherein the distributing step includes the step of:
donating the second quantity of the death benefit to the non-profit entity.

81. The method according to claim 52, wherein the securing step includes the step of:
defining a percentage of a death benefit of the life insurance policy as the first portion of the proceeds.

82. The method according to claim 81, wherein the defining step includes the step of:
varying the percentage of the death benefit as a function of time.

83. The method according to claim 82, further comprising the step of:
setting forth the varying percentage of the death benefit in a collateral schedule in a loan agreement.

84. A method for enabling donations of life insurance proceeds by a donor to a beneficiary, comprising the steps of:
supplying annuity payments to a life insurance trust, the life insurance trust holding a life insurance policy on a donor in trust and a loan on a death benefit of the life insurance policy, the life insurance trust using the annuity payments to finance the loan and the life insurance policy on the donor, a first portion of the death benefit being allocated to the loan and a second portion of the death benefit being allocated to the beneficiary; and
receiving a lump sum consideration from the life insurance trust for the annuity payments equal to a principal amount of the loan.

85. The method according to claim 84, further comprising the step of:
insuring the annuity payments for a life of the donor.

86. The method according to claim 85, wherein the insuring step includes the step of:
purchasing reinsurance for the annuity payments from an annuity reinsurance company.

87. The method according to claim 85, wherein the insuring step includes the step of:
purchasing reinsurance for the annuity payments for a price equal to the principal amount of the loan.

88. The method according to claim 85, wherein the insuring step includes the step of:
purchasing reinsurance for the annuity payments for a lump sum equal to a fair cost of the private annuity on a life of the donor.

89. A method for enabling donations of life insurance proceeds by a donor to a beneficiary, comprising the steps of:
determining a principal amount for a loan to a life insurance trust on a life insurance policy on the donor held by the life insurance trust, as a function of a death benefit of the life insurance policy; and
defining a portion of the death benefit of the life insurance policy as collateral for the loan, to be allocated to the loan upon a death of the donor, another portion of the death benefit to be allocated to the beneficiary.

90. The method according to claim 89, further comprising the step of:
establishing a term of the loan as a duration of the life of the donor.

91. The method according to claim 89, further comprising the step of:
configuring periodic payments on the loan as interest payments payable by the life insurance trust, the interest payments being covered by the life insurance trust with a portion of annuity payments provided to the life insurance trust, the annuity payments being purchased by the life insurance trust with the principal amount of the loan.

92. The method according to claim 89, further comprising the step of:
offering the loan to the life insurance trust for the life insurance trust to purchase an annuity, annuity payments from the annuity covering interest payments on the loan and premiums on the life insurance policy.

93. The method according to claim 92, wherein the offering step includes the step of:
offering the loan to the life insurance trust for the life insurance trust to purchase a private annuity, the private annuity providing insured annuity payments to the life insurance trust.

94. A method for enabling donations of life insurance proceeds by a donor to a beneficiary, comprising the step of:
insuring annuity payments purchased by a life insurance trust for a life of a donor with a loan secured by a first portion of a death benefit from a life insurance policy on the donor held by the life insurance trust in trust, the annuity payments financing the loan and the life insurance policy,
wherein a second portion of the death benefit is allocated to a beneficiary upon death of the donor.

95. The method according to claim 94, wherein the insuring step includes the step of:
selling reinsurance on the annuity payments to a private annuity trust obligor for a lump sum equal to a fair cost of the annuity payments on the life of the donor.

96. The method according to claim 94, wherein the insuring step includes the step of:
selling reinsurance on the annuity payments to a private annuity trust obligor for a purchase price equal to a principal amount of the loan, the principal amount being determined as a function of a value of the death benefit of the life insurance policy.

97. The method according to claim 94, wherein the insuring step includes the step of:
providing insured annuity payments to a private annuity trust obligor, for the private annuity trust obligor to provide to the life insurance trust.

98. The method according to claim 97, wherein the insuring step includes the step of:
receiving a lump sum payment from the private annuity trust obligor equal to a fair cost of the annuity payments on the life of the donor.

99. The method according to claim 98, further comprising the step of:
investing an amount of the lump sum payment in an investment fund.

100. The method according to claim 99, further comprising the step of:
receiving a rate of return on the invested amount from the investment fund.

101. The method according to claim 98, further comprising the step of:
receiving equity investments from an investment fund.

102. The method according to claim 94, further comprising the step of:
providing loss reserves on insurance for the annuity payments to an investment fund, the investment fund managing the loss reserves.

103. A method for enabling donations of life insurance proceeds by a donor to a beneficiary, comprising the step of:
investing in a lending entity that provides a loan to a life insurance trust collateralized with assets held by the life insurance trust, the assets including a first portion of proceeds on a life insurance policy on a donor held by the life insurance trust in trust, a second portion of the proceeds on the life insurance policy being designated as a donation to the beneficiary upon death of the donor; and
investing in a reinsurance entity that provides insurance to an annuity paying entity on annuity payments supplied by the annuity paying entity to the life insurance trust for the life of the donor, the annuity payments financing the loan and the life insurance policy.

104. The method according to claim 103, further comprising the step of:
managing loss reserves of the reinsurance entity.

105. The method according to claim 104, wherein the step of investing in the lending entity, includes the step of:
investing interest on the loss reserves in the lending entity.

106. The method according to claim 103, wherein the step of investing in the lending entity, includes the step of:
investing the loss reserves in the lending entity.

107. The method according to claim 103, wherein the step of investing in the lending entity, includes the step of:
making a loan to the lending entity.

108. The method according to claim 103, wherein the step of investing in the lending entity, includes the step of:
providing debt investments to the lending entity.

109. The method according to claim 103, further comprising the step of:
receiving equity from fund investors.

110. The method according to claim 109, further comprising the step of:
providing a return on the equity to the fund investors.

111. The method according to claim 109, further comprising the step of:
managing the equity and the investments.

112. The method according to claim 111, wherein the managing step includes the step of:
appointing an investment fund manager to manage an investment fund, the investment fund receiving the equity and providing the investments to the reinsurance entity and to the lending entity.

113. The method according to claim 112, wherein the managing step includes the step of:
providing management fees to the investment fund manager for the management of the investment fund.

114. The method according to claim 111, wherein the managing step includes the step of:
monitoring the investments in the reinsurance company and in the lending entity for adequacy of return given an amount of risk entailed by each investment.

115. The method according to claim 103, wherein the step of investing in the lending entity, includes the step of:
investing in an asset-based finance company, the asset-based finance company being the lending entity providing the loan to the life insurance trust.

116. The method according to claim 103, wherein the step of investing in the reinsurance company, includes the step of:
investing in an annuity reinsurance company, the annuity reinsurance company being the reinsurance entity providing insurance to the annuity paying entity.

117. The method according to claim 116, wherein the step of investing in the annuity reinsurance company includes the step of:
investing in the annuity reinsurance company, the annuity reinsurance company providing insurance to a private annuity trust obligor, the private annuity trust obligor being the annuity paying entity supplying the annuity payments to the life insurance trust.

118. A method for enabling donations of life insurance proceeds by a donor to a beneficiary, comprising the step of:
investing in a lending entity that provides a loan to a life insurance trust for a purchase of an annuity, the loan being collateralized with assets held by the life insurance trust, the assets including a first portion of proceeds on a life insurance policy on a donor held by the life insurance trust in trust, a second portion of the proceeds on the life insurance policy being designated as a donation to the beneficiary upon death of the donor,
wherein annuity payments from the annuity finance the loan and the life insurance policy.

119. A method for enabling donations of life insurance proceeds by a donor to a beneficiary, comprising the step of:
investing in a reinsurance entity that provides insurance to an annuity paying entity on annuity payments purchased by a life insurance trust for a lifetime of a donor, the life insurance trust purchasing the annuity payments with a loan taken by the life insurance trust, the loan being secured with a life insurance policy on the donor held by the life insurance trust in trust, the annuity payments financing the loan and the life insurance policy.

120. A system enabling donations of life insurance proceeds to a non-profit entity, comprising:
a life insurance trust holding a life insurance policy on a life of a donor in trust; and
a non-profit fund separate from the non-profit entity, the non-profit fund providing funds to the life insurance trust for financing the life insurance policy;
wherein the life insurance trust establishes a distribution of proceeds from the life insurance policy to the non-profit entity and the non-profit fund.

121. The system according to claim 120, wherein the non-profit entity is a first beneficiary of the life insurance policy.

122. The system according to claim 121, wherein the non-profit fund is a second beneficiary of the life insurance policy.

123. The system according to claim 120, wherein the non-profit fund is an endowment investment fund related to and separate from the non-profit entity.

124. The system according to claim 120, wherein the non-profit entity is one of a university and a college.

125. The system according to claim 124, further comprising a gift fund of the one of the university and the college, the gift fund receiving the proceeds distributed to the one of the university and the college from the life insurance policy.

126. The system according to claim 120, wherein the life insurance trust is an irrevocable life insurance trust.

127. The system according to claim 120, further comprising:
the life insurance policy on the life of the donor.

128. The system according to claim 120, further comprising:
an issuing insurer issuing the life insurance policy on the life of the donor.

129. The system according to claim 128, wherein the issuing insurer accepts premium payments from the life insurance trust.

130. The system according to claim 128, wherein the issuing insurer pays a death benefit on the life insurance policy to the life insurance trust upon a death of the donor.

131. The system according to claim 128, wherein the life insurance trust includes a life insurance trustee, the life insurance trustee representing interests of beneficiaries of the trust, the beneficiaries including the non-profit entity and the non-profit fund.

132. The system according to claim 131, wherein the life insurance trustee is assigned duties under the trust, the duties including at least one of: opening a bank account, depositing funds received from the non-profit fund in the bank account, paying premiums on the life insurance policy with the deposited funds in the bank account, collecting death benefits as the proceeds of the life insurance policy upon a death of the donor, disbursing the death benefits to the beneficiaries of the trust.

133. The system according to claim 120, further comprising:
a bank account accepting deposits of the funds from the non-profit fund and providing cash to the life insurance trust to pay premiums on the life insurance policy in order to finance the life insurance policy.

134. The system according to claim 133, further comprising:
a bank custodian managing the bank account.

135. A system enabling donations of life insurance proceeds to a non-profit entity, comprising:
a life insurance trust holding in trust at least one life insurance policy on each of at least one donor to the non-profit entity; and
a non-profit fund separate from the non-profit entity, the non-profit fund providing funds to the life insurance trust for financing each life insurance policy on each donor;
wherein the life insurance trust establishes a distribution of proceeds from each life insurance policy to the non-profit entity and the non-profit fund.

136. The system according to claim 135, further comprising:
a cohort of select donors, each of the select donors being one of the at least one donor to the non-profit institution.

137. The system according to claim 136, further comprising:
a cohort of potential donors, each of the select donors being selected from the cohort of potential donors.

138. The system according to claim 137, further comprising:
an alumni database providing information on each potential donor in the cohort of potential donors.

139. The system according to claim 138, further comprising:
a select donor list generated by processing the information in the alumni database according to at least one underwriting criterion.

140. The system according to claim 136, further comprising:
at least one insurance agent processing life insurance applications on the select donors.

141. The system according to claim 140, wherein, for each select donor, the at least one insurance agent contacts a plurality of issuing insurers and determines an optimal life insurance policy minimizing costs for the financing and maximizing the proceeds for distribution.

142. The system according to claim 135, further comprising:
at least one life insurance policy on each of the at least one donor.

143. The system according to claim 142, wherein each of the at least one life insurance policy can be one of a universal life insurance policy, a whole life insurance policy, a variable life insurance policy and a term life insurance policy.

144. The system according to claim 135, further comprising:
a portfolio manager managing the funds provided by the non-profit entity to the life insurance trust.

145. A system enabling donations of life insurance proceeds to a non-profit entity, comprising:
a life insurance policy on a life of a donor, the life insurance policy being held in trust by a life insurance trust, financed by the life insurance trust with funds provided to the life insurance trust from a non-profit fund separate from the non-profit entity, wherein proceeds from the life insurance policy are distributed by the life insurance trust to the non-profit entity and the non-profit fund.

146. An investment vehicle in a non-profit investment fund supporting life insurance donations to a non-profit entity, the investment vehicle comprising:
a tradable instrument providing investment capital to the non-profit investment fund, the non-profit investment fund being separate from the non-profit entity, funds from the non-profit investment fund being provided to a life insurance trust to finance a life insurance policy on a life of a donor,
wherein the life insurance trust holds the life insurance policy in trust and establishes a distribution of proceeds from the life insurance policy to the non-profit investment fund and the non-profit entity.

147. The investment vehicle according to claim 146, wherein the non-profit investment fund is an endowment investment fund, and the non-profit entity is one of a university and a college related to and separate from the endowment investment fund.

148. A system enabling donations of life insurance proceeds to a beneficiary, comprising:
a life insurance policy on a life of a donor, the life insurance policy being held in trust by a life insurance trust;
a loan taken by the life insurance trust collateralized with the life insurance policy; and
an annuity purchased by the life insurance trust with a principal amount of the loan, annuity payments from the annuity financing the loan and the life insurance policy,
wherein a first portion of a death benefit of the life insurance policy is allocated for the loan, and a second portion of the death benefit is allocated for donation to the beneficiary.

149. An investment vehicle in an investment fund supporting life insurance donations to beneficiaries, the investment vehicle comprising:
a tradable instrument providing investment capital to an investment fund, the investment fund investing the investment capital in a lending entity and a reinsurance entity,
wherein the lending entity provides a loan to a life insurance trust collateralized with a life insurance policy on a donor, the loan being provided for the life insurance trust to purchase annuity payments from an annuity paying entity, the life insurance policy being held by the life insurance trust in trust, a first portion of a death benefit of the life insurance policy being designated as collateral for the loan and a second portion of the death benefit being designated as a donation to a beneficiary, and
wherein the reinsurance entity provides insurance to the annuity paying entity on the annuity payments purchased by the life insurance trust from the annuity paying entity, the annuity payments financing the loan and the life insurance policy.

150. A debt investment vehicle to enable life insurance donations to beneficiaries, the debt investment vehicle comprising:
a loan to a borrower for a purchase of an annuity on a lifetime of a donor, the loan being secured by a life insurance policy on a donor, the life insurance policy being held by the borrower in a trust, the annuity financing the loan and the life insurance policy,
wherein a first portion of a death benefit of the life insurance policy is allocated to repay the loan, and a second portion of the death benefit is allocated for donation to a beneficiary.

151. The debt investment vehicle according to claim 150, wherein annuity payments from the annuity are applied to pay interest on the loan and premiums on the life insurance policy.

152. A system enabling life insurance donations to beneficiaries, the system comprising:
insurance on an annuity providing annuity payments to a life insurance trust for a life of a donor, the annuity purchased by the life insurance trust with a loan on a life insurance policy on the life of the donor, the life insurance trust holding the life insurance policy in trust, the annuity payments covering interest on the loan and premiums on the life insurance policy,
wherein a first portion of a death benefit of the life insurance policy is assigned as collateral for the loan, and a second portion of the death benefit is allocated as a donation to a beneficiary.

153. A system enabling donations of life insurance proceeds to a beneficiary, comprising:
a life insurance trust holding a life insurance policy on a life of a donor in trust;
a lending entity providing a loan to the life insurance trust on the life insurance policy,
a first portion of a death benefit of the life insurance policy being assigned as collateral for the loan, and a second portion of the death benefit being allocated as a donation to a beneficiary; and
an annuity paying entity providing annuity payments to the life insurance trust for the life of the donor in exchange for a principal amount of the loan, the annuity payments covering interest payments on the loan and premiums on the life insurance policy.

154. The system according to claim 153, further comprising:
a reinsuring entity providing insured annuity payments to the annuity paying entity for a lump sum equal to a cost of the annuity payments on the life of the donor.

155. The system according to claim 154, wherein the reinsuring entity is an annuity reinsurance company.

156. The system according to claim 153, wherein the life insurance trust is an irrevocable life insurance trust.

157. The system according to claim 153, wherein the lending entity is an asset-based finance company.

158. The system according to claim 153, wherein the annuity paying entity is a private annuity trust obligor.

159. The system according to claim 153, further comprising:
an investment fund managing loss reserves for the reinsuring entity.

160. The system according to claim 153, further comprising:
an investment fund investing in the lending entity and the reinsuring entity.

161. The system according to claim 160, further comprising:
an investment fund manager managing the investments of the investment fund in the lending entity and the reinsuring entity.

162. The system according to claim 160, further comprising:
investors investing equity in the investment fund.

163. A method for enabling donations of life insurance proceeds by a donor to a beneficiary, comprising the steps of:
purchasing an annuity with a loan;
securing the loan with a life insurance policy;
financing the loan and the life insurance policy with the annuity;
allocating a first portion of proceeds of the life insurance policy to repay the loan; and
allocating a second portion of the proceeds of the life insurance policy to the beneficiary.

164. The method according to claim 163, wherein the step of allocating the second portion, includes the step of:
defining a non-profit entity as the beneficiary.

165. The method according to claim 163, wherein the financing step includes the step of:
using annuity payments from the annuity to pay interest on the loan and premiums on the life insurance policy.

166. A method for financing an annuity on a lifetime of a donor comprising the step of:
offering a loan for purchasing the annuity, with requirements including:
collateralizing the loan with a life insurance policy on the donor; and
using the annuity to finance the loan and the life insurance policy.

167. The method according to claim 166, wherein the offering step includes the step of:
offering the loan to a life insurance trust for purchasing the annuity, the life insurance trust holding the life insurance policy in a trust.

168. The method according to claim 167, wherein the step of offering the loan to the life insurance trust includes the step of:
offering the loan with a requirement that a first portion of proceeds of the life insurance policy are allocated by the life insurance trust to repay the loan, the life insurance trust allocating a second portion of the proceeds to a beneficiary.
